(19) United States
(12) Patent Application Publication
(10) Pub. No.: US 2020/0382767 A1
(43) Pub. Date: Dec. 3, 2020

(54) MOTION COMPENSATION REFERENCE FRAME COMPRESSION

(71) Applicants: INTOPIX SA, Mont-Saint-Guibert (BE); UNIVERSITE CATHOLIQUE DE LOUVAIN, Louvain-la-Neuve (BE)

(72) Inventors: Alexandre WILLEME, Louvain-la-Neuve (BE); Antonin DESCAMPE, Louvain-la-Neuve (BE); Gael ROUVROY, Mont-Saint-Guibert (BE); Pascal PELLEGRIN, Mont-Saint-Guibert (BE); Benoit MACQ, Louvain-la-Neuve (BE)

(21) Appl. No.: 16/636,200

(22) PCT Filed: Aug. 6, 2018
(86) PCT No.: PCT/EP2018/071307

§ 371 Date: Feb. 3, 2020

(30) Foreign Application Priority Data
Aug. 4, 2017 (EP) 17185038.1

(51) Int. Cl. H04N 19/105; H04N 19/433; H04N 19/52; H04N 19/139; H04N 19/167; H04N 19/176

(52) U.S. Cl. CPC H04N 19/105; H04N 19/433; H04N 19/176; H04N 19/139; H04N 19/167; H04N 19/52

(57) ABSTRACT

In a video encoder (100), a motion estimation module (102) identifies for a portion of a frame to be encoded, a similar portion in a reference frame. The reference frame is a decoded version of an already encoded frame. A reference frame compression module (104) independently encodes respective portions of the reference frame so as to obtain respective encoded portions of the reference frame. The respective portions of the reference frame that are independently encoded are at least as large as the portion of the frame to be encoded. A reference frame memory (108) temporarily stores the respective encoded portions of the reference frame as an encoded representation of the reference frame. A reference frame decompression module (105) decodes an encoded portion of the reference frame stored in the reference frame memory (108), so as to obtain a decoded version of the encoded portion of the reference frame. A cache memory (107) stores a set of contiguous decoded versions of encoded portions of the reference frame. The motion estimation module (102) accesses the cache memory (107) so as to identify the similar portion in the reference frame among the set of contiguous decoded versions of encoded portions of the reference frame.

### FIELD OF THE INVENTION

An aspect of the invention relates to an encoder adapted to encode a sequence of frames so as to obtain an encoded sequence of frames. The encoder may be, for example, of the HEVC type, HEVC being an acronym for High Efficiency Video Coding formally known as ISO 23008-2:2015|ITU-T Rec. H.265. Other aspects of the invention relate to a method of encoding a sequence of frames and a computer program.

### BACKGROUND ART

In HEVC, inter-picture prediction exploits temporal redundancy within frames of a video sequence. Inter-picture prediction may predict information comprised in a frame using information available in previously encoded frames of the video sequence. These previously encoded frames then constitute reference frames.

Inter-picture prediction in HEVC can be summarized as follows. First, an encoder splits a frame to be encoded into block-shaped regions. Then, for each of these block-shaped regions, a motion estimation module of the encoder applies a block matching strategy in order to identify motion data. This motion data comprises a reference frame index indicating which previously encoded frame is used as reference for prediction. The motion data further comprises a motion vector specifying a relative position of a similar block-shaped region in the reference frame. A motion compensation module may then generate predicted frames using the motion data.

In order to carry out inter-picture prediction, an HEVC encoder needs to temporarily store a decoded version of an encoded frame, which may constitute a reference frame in encoding a subsequent frame. To that end, an HEVC encoder comprises a memory, which is generally referred to as reference frame buffer. The reference frame buffer needs to store a relatively large amount of data. What is more, the reference frame buffer needs to sustain a relatively high access bandwidth. For example, let it be assumed that an HEVC encoder works on 2160p30 4:2:0 8-bits content. In that case, read accesses to reference frame buffer for inter-picture prediction may require an access bandwidth as high as 6.7 GB/s.

The reference frame buffer may be implemented by means of a dynamic random access memory (DRAM), which may provide relatively large storage capacity and relatively high access bandwidth at relatively low cost. In such an implementation, other functional modules of an HEVC encoder may be comprised in an integrated circuit, a so-called chip. However, accesses by the chip to the DRAM may entail relatively high power consumption, in particular when high bandwidth is required as mentioned hereinbefore. The accesses by the chip to the DRAM may account for a significant portion of an overall power consumption of the HEVC encoder. For example, the accesses may account for nearly half of the overall power consumption, or even more than half.

### SUMMARY OF THE INVENTION

There is a need for a solution that allows a video encoder to better meet at least one of the following criteria: low power consumption and moderate cost, whereby encoded video that has been generated provides satisfactory image quality when decoded.

In accordance with an aspect of the invention as defined in claim 1, there is provided an encoder adapted to encode a sequence of frames so as to obtain an encoded sequence of frames, the encoder comprising:
a motion estimation module adapted to identify for a portion of a frame to be encoded, a similar portion in a reference frame, the reference frame being a decoded version of an already encoded frame;

wherein the encoder comprises a reference frame buffer system including:
a reference frame compression module adapted to independently encode respective portions of the reference frame so as to obtain respective encoded portions of the reference frame, whereby the respective portions of the reference frame that are independently encoded are at least as large as the portion of the frame to be encoded;
a reference frame memory adapted to temporarily store the respective encoded portions of the reference frame as an encoded representation of the reference frame;
a reference frame decompression module adapted to decode an encoded portion of the reference frame stored in the reference frame memory, so as to obtain a decoded version of the encoded portion of the reference frame; and
a cache memory adapted to store a set of contiguous decoded versions of encoded portions of the reference frame,

whereby the motion estimation module is adapted to access the cache memory so as to identify the similar portion in the reference frame among the set of contiguous decoded versions of encoded portions of the reference frame.

In such an encoder, accesses to the reference frame memory essentially concern respective encoded portions of a reference frame, which constitute an encoded representation of the reference frame. The respective encoded portions of the reference frame may comprise a relatively small amount of data compared with original portions of the reference frame. This may significantly relax bandwidth requirements associated with such accesses. A significant reduction in bandwidth may be achieved, in particular if a lossy encoding is used for the portions of the reference frame. In principle, such a lossy encoding may affect coding efficiency or image quality, or both. However, it has been found that, in practice, a loss in coding efficiency or image quality, or both may be relatively small and may even be insignificant.

A further factor that contributes to significantly relaxing bandwidth requirements without significantly compromising coding efficiency or image quality, or both, is that the respective portions of the reference frame that are independently encoded are at least as large as the portion of the frame to be encoded. Since the respective portions of the reference frame are relatively large, a relatively high compression ratio can be achieved without significant loss of image quality. That is, applying a relatively high compression ratio, which allows relaxing bandwidth requirements, does not necessarily prevent the representation of the reference frame that is used for motion estimation and motion compensation to be a relatively high-quality copy of the reference frame in its original form. These factors, which relax bandwidth requirements without significantly affecting image quality, allow reduction of power consumption.

In accordance with further aspects of the invention as defined in claims 14 and 15, a method of encoding a sequence of frames and a computer program are provided.

For the purpose of illustration, some embodiments of the invention are described in detail with reference to accompanying drawings. In this description, additional features will be presented and advantages will be apparent.

### BRIEF DESCRIPTION OF THE DRAWINGS

FIG. 1 is a block diagram of a video encoder.

FIG. 2 is a conceptual diagram of a sequence of frames to be encoded.

FIG. 3 is a conceptual diagram of respective block-like portions of a future reference frame that may be defined and processed in a reference frame compression module.

FIG. 4 is a conceptual diagram of respective stripe-like portions of a future reference frame that may be defined and processed in the reference frame compression module.

FIG. 5 is a conceptual diagram of a present portion of a present frame to be encoded on the basis of a representation of a fraction of a reference frame present in a cache memory.

FIG. 6 is a conceptual diagram of a subsequent portion of the present frame to be encoded on the basis of a representation of another fraction of the reference frame present in the cache memory.

FIG. 7 is a graph in which image quality is plotted against encoded video bit rate for various video encoding and decoding schemes.

### DESCRIPTION OF SOME EMBODIMENTS

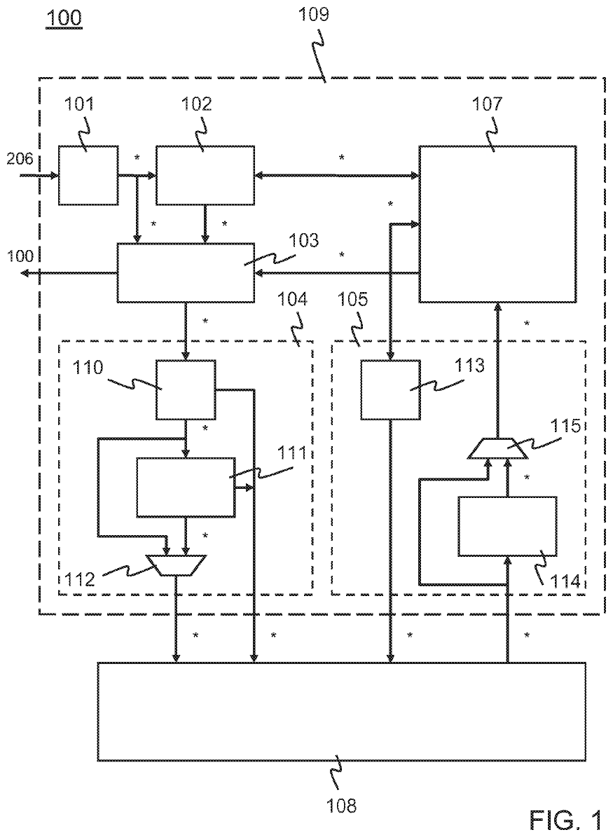

FIG. 1 schematically illustrates a video encoder 100. FIG. 1 provides a block diagram of the video encoder 100. The video encoder 100 may be, for example, of the HEVC type, HEVC being an acronym for High Efficiency Video Coding, formally known as ISO 23008-2:2015|ITU-T Rec. H.265.

The video encoder 100 comprises various functional modules: a frame portion definition module 101, a motion estimation module 102, a main encoding module 103, a reference frame compression module 104, and a reference frame decompression module 105. The aforementioned functional modules may be in the form of, for example, dedicated circuits that are adapted to carry out operations that will be described hereinafter.

The video encoder 100 further comprises a cache memory 107 and a reference frame memory 108. The cache memory 107 and the aforementioned functional modules 101-105 may be comprised in an integrated circuit, a so-called chip 109. The reference frame memory 108 may be in the form of, for example, a dynamic random access memory that is coupled to the chip 109, which comprises the aforementioned functional modules 101-105 and the cache memory 107.

In more detail, the reference frame compression module 104 comprises a reference frame portion definition module 110, a reference frame encoder module 111, and a reference frame encoder multiplexer 112. The reference frame decompression module 105 comprises a cache memory management module 113, a reference frame decoder module 114, and a reference frame decoder multiplexer 115. The reference frame compression module 104, the reference frame decompression module 105, the reference frame memory 108, and the cache memory 107 can be regarded as forming a reference frame buffer system within the video encoder 100.

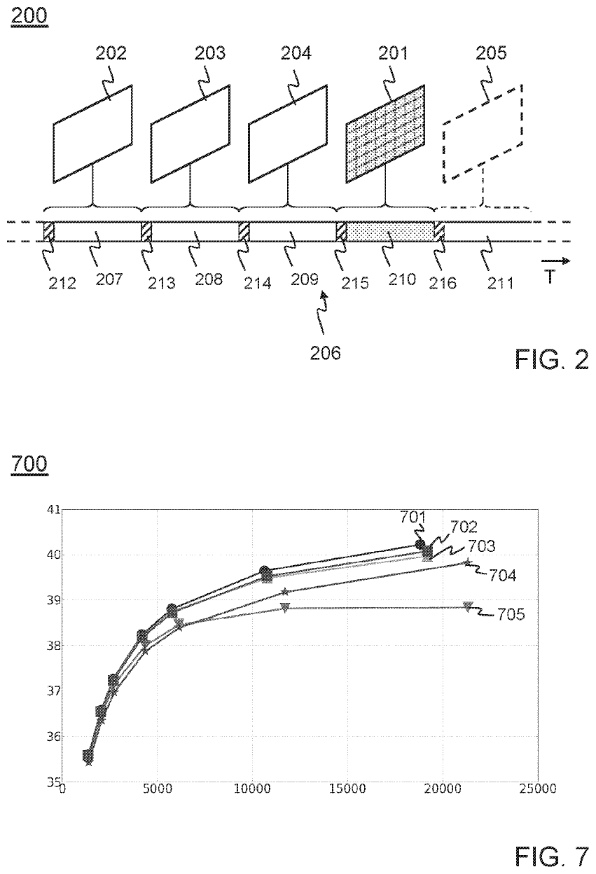

FIG. 2 schematically illustrates a sequence of frames 200 to be encoded by the video encoder 100 illustrated in FIG. 1. FIG. 2 provides a conceptual diagram of a sequence of frames 200 to be encoded. The sequence of frames comprises a frame 201 that is presently to be encoded, which is preceded by several frames 202-204 that have already been encoded and followed by a frame 206 to be subsequently encoded. The frame 201 that is presently to be encoded will be referred to hereinafter as the present frame 201 for the sake of convenience. The sequence of frames 200 to be encoded may be a rearranged version of a sequence of frames originally comprised in a video. That is, an order in which frames occur may be changed for the purpose of encoding.

The sequence of frames is provided to the video encoder 100 in the form of a data stream 206. The data stream 206 comprises successive segments 207-211, whereby a segment represents a frame to be encoded. The data stream 206 further comprises various indicators 212-216 that provide information about the data stream 206 and the frames that the data stream 206 represents. For example, an indicator may indicate a start of a segment and thus a start of a frame to be encoded. The data stream 206 illustrated in FIG. 2, which represents the sequence of frames 200 to be encoded by the video encoder 100, may have a structure and syntax similar to, and even identical with, data streams applied to conventional video encoders, such as, for example encoders of the HEVC type.

The video encoder 100 illustrated in FIG. 1 may operate as described in what follows. In this description, certain features of HEVC are deliberately disregarded, or rather simplified, for the sake of clarity and simplicity.

The video encoder 100 may encode a frame in an intra-frame manner or in an inter-frame manner. In the intra-frame manner, the frame is encoded singly, without reference to a previously encoded frame. In the inter-frame manner, the frame is encoded with reference to a previously encoded frame. More precisely, the frame is encoded with reference to a decoded version of a previously encoded frame. This decoded version constitutes a reference frame. It is noted that, in HEVC, a frame may be encoded in a mixed intra/inter-frame manner: certain portions of the frame may be encoded in the intra-frame manner, whereas other portions may be encoded in the inter-frame manner. This feature is disregarded for the sake of clarity and simplicity.

The video encoder 100 may apply a frame encoding scheme that determines which frames are to be encoded in the intra-frame manner and which frames are to be encoded in the inter-frame manner. Such a frame encoding scheme may be in the form of a repetitive pattern, wherein a predefined number of frames that are encoded in the inter-frame manner are comprised between two successive frames that are encoded in the intra-frame manner.

It is assumed that the video encoder 100 receives the data stream 206 illustrated in FIG. 2 and, more particularly, a segment 210 that represents the present frame 201. It is further assumed that the present frame 201 is encoded in the inter-frame manner. This implies that a decoded version of a previously encoded frame constitutes a reference frame for the present frame 201 to be encoded. In HEVC, a frame may be encoded with reference to multiple reference frames. This feature is disregarded for the sake of clarity. It is assumed that the present frame 201 is encoded with reference to a single reference frame.

The frame portion definition module 101 successively defines respective portions of the present frame 201. A portion of the present frame 201 that the frame portion definition module 101 presently defines may correspond with elements in the data stream 206 that the video encoder 100 presently receives. The portion of the present frame 201 that the frame portion definition module 101 presently defines will be referred to hereinafter as the present portion of the present frame 201 to be encoded. The respective portions that the frame portion definition module 101 defines may have a predefined maximum size of, for example, 64×64 pixels. For example, assuming that the video encoder 100 is of the HEVC type, such a portion may correspond with a so-called coding tree unit (CTU). It is noted that, in HEVC, portions of a frame to be encoded may vary in size. This feature is disregarded for the sake of clarity and simplicity.

The frame portion definition module 101 may be regarded as an entity that, in effect, divides the frame to be encoded into individual blocks of pixels. This is illustrated in FIG. 2, wherein the present frame 201 is, in effect, divided into blocks of pixels. These blocks of pixels constitute a two-dimensional array, which corresponds with the present frame 201. The video encoder 100 may individually encode these blocks of pixels on a block by block basis.

The cache memory management module 113 of the reference frame decompression module 105 ensures that the cache memory 107 comprises a representation of a particular fraction of the reference frame. This particular fraction may include a portion of the reference frame, or rather the representation thereof, which coincides in position with the present portion of the present frame 201 that is to be encoded.

The motion estimation module 102 accesses the cache memory 107 so as to identify, for the present portion of the present frame 201 to be encoded, a similar portion in the reference frame. This search for a similar portion is restricted to the fraction of the reference frame of which the representation is present in the cache memory 107.

The motion estimation module 102 may apply a search window within which a similar portion is searched for and thus identified. The search window may have a fixed position with respect to the portion of the frame to be encoded. For example, the search window may have a center that corresponds in position with a center of the present portion of the present frame 201 to be encoded. Stated otherwise, the search window may be centered on the present portion of the present frame 201 to be encoded.

The motion estimation module 102 provides a motion vector for the present portion of the present frame 201 to be encoded. The motion vector indicates a position of the similar portion in the reference frame that has been identified relative to the present portion of the present frame 201 to be encoded. It is noted that in HEVC, multiple motion vectors may be provided for a portion of the frame to be encoded if the portion is encoded with reference to multiple reference frames. This feature is disregarded for the sake of clarity and simplicity.

The main encoding module 103 encodes a residue, which is the difference that may exist between the present portion of the present frame 201 to be encoded and the similar portion in the reference frame that has been identified. To that end, the main encoding module 103 may use the motion vector to retrieve this similar portion from the cache memory 107. The main encoding module 103 thus generates an encoded present portion of the present frame 201, which includes the motion vector and an encoded residue between the present portion of the present frame 201 and the similar portion in the reference frame indicated by the motion vector.

In encoding the present frame 201, the main encoding module 103 thus generates a series of respective encoded portions of the present frame 201. This series of respective encoded portions of the present frame 201 essentially constitutes an encoded present frame. The main encoding module 103 may output the encoded present frame in the form of a data stream segment.

The main encoding module 103 further generates a decoded version of the encoded present portion of the present frame 201. The decoded version may be obtained by applying operations to the encoded present portion of the present frame 201 similar to those that will normally be applied in a decoder adapted to decode the encoded present frame. These operations may comprise, for example, motion compensation, and decoded frame reconstruction using the encoded residue.

In encoding the present frame 201, the main encoding module 103 thus generates a series of respective decoded versions of encoded portions of the present frame 201. This series of respective encoded portions of the present frame 201 essentially constitutes a decoded version of the encoded present frame. The decoded version of the encoded present frame 201 may constitute a reference frame for a subsequent frame to be encoded. The decoded version of the encoded present frame 201 will be referred to hereinafter as future reference frame for the sake of convenience and clarity.

The reference frame portion definition module 110 of the reference frame compression module 104 successively defines respective portions of the future reference frame. A portion of the future reference frame that the reference frame portion definition module 110 presently defines may comprise the decoded version of the encoded present portion of the reference frame. The respective portions of the future reference frame that the reference frame portion definition module 110 defines may have a width of at least 64 pixels and a height of at least 32 pixels. That is, the respective portions of the future reference frame that are processed in the reference frame compression module 104 are relatively large, at least comparable in size with the respective portions into which a frame to be encoded is, in effect, divided.

FIG. 3 schematically illustrates respective block-like portions of the future reference frame that may be defined and processed in the reference frame compression module 104. FIG. 3 provides a conceptual diagram of the respective block-like portions of the future reference frame. In this example, the respective portions of the future reference frame may have a size of at least 64 by 64 pixels.

FIG. 4 schematically illustrates respective stripe-like portions of the future reference frame that may be defined and processed in the reference frame compression module 104. FIG. 4 provides a conceptual diagram of the respective stripe-like portions of the future reference frame. In this example, the respective portions of the future reference frame may have a size of at least 64 pixels in height and a width corresponding to that of the frames in the sequence of frames illustrated in FIG. 2.

The reference frame encoder module 111 independently encodes the respective portions of the future reference frame that have been defined. Accordingly, the reference frame encoder module 111 generates respective encoded portions of the future reference frame. These respective encoded portions constitute an encoded representation of the future reference frame.

The encoded representation of the future reference frame may comprise an amount of data that is, for example, half of the amount of data that the future reference frame comprises in its original version, or even less than half That is, the reference frame encoder module 111 may provide a compression ratio of at least 2. More specifically, the reference frame encoder module 111 may systematically provide a compression ratio of at least 2. This means that each of the respective encoded portions of the future reference frame comprises an amount of data that is half the amount of data comprised in each of the respective decoded versions of encoded portions of the present frame 201, or less than half. The compression ratio may even be higher, such as, for example, 3, 4, 5, or even higher.

A compression ratio of at least 2 or even higher generally implies that encoding of the reference frame may not be lossless in term of quality. The encoded version of the future reference frame may have a somewhat degraded quality when decoded compared with the future reference frame in its original version. One would expect this to significantly affect image quality that the video encoder 100 can provide, in particular if there is a series of successive frames that are encoded in the inter-frame manner. However, surprisingly, it has been found that a relatively high compression ratio when encoding reference frames need not necessarily entail a significant loss in image quality.

The compression ratio that reference frame encoder module 111 provides may depend on the size of the respective portions of the reference frame that are independently encoded. For example, in case the reference frame portion definition module 110 defines stripe-like portions as illustrated in FIG. 4, the compression ratio may be higher than in the case that this module defines block-like portions as illustrated in FIG. 3. In general, it holds that the larger the size is of the respective portions of the reference frame that are defined and individually encoded, the higher the compression ratio may be for a given encoded video quality.

The reference frame encoder module 111 may operate in accordance with a constant data rate encoding scheme. This means that the compression ratio is constant for the respective decoded versions of encoded portions of the present frame 201. Accordingly, in this case, the respective encoded portions of the future reference frame that the reference frame encoder module 111 generates have a fixed size, that is, comprise a fixed amount of data.

The reference frame encoder module 111 may operate in accordance with, for example, a JPEG XS encoding scheme. JPEG XS designates low-latency lightweight image compression that is able to support increasing resolution, such as 8K, and frame rate in a cost-effective manner. JPEG XS is currently in the state of a draft international standard at the ISO/IEC SC 29 WG 01 better known as JPEG committee. JPEG XS is registered as ISO/IEC 21122.

The reference frame compression module 104 may transfer the respective encoded portions of the future reference frame to the reference frame memory 108 via the reference frame encoder multiplexer 112. The reference frame encoder multiplexer 112 allows the reference frame buffer system to store a portion of the future reference frame in the reference frame memory 108 in its original version, without being encoded. This case may apply, for example, if a boundary portion of the future reference frame is smaller than the respective portions of the future reference frame that are encoded for storage in the reference frame memory 108. For example, referring to FIG. 3, such boundaries may exist if the respective block-like portions of the size of 64×64 pixels, whereas the frame has a width that is not an exact multiple of 64 pixels, or the frame has a height that is not an exact multiple of 64 pixels, or both.

The reference frame compression module 104 may further transfer to the reference frame memory 108 information concerning the respective encoded portions of the future reference frame to be stored therein. For example an index may be associated with an encoded portion of the future reference frame. The index may indicate a position of the encoded portion within the future reference frame.

As another example, in case the reference frame encoder module 111 applies a variable data rate encoding scheme, a data size indication may be associated with an encoded portion of the future reference frame. The data size indication may serve to appropriately manage storage of the respective encoded portions of the future reference frame in the reference frame memory 108. In case the reference frame encoder module 111 applies a constant data rate encoding scheme, such a data size indication may be dispensed with. In this case, the respective encoded portions of the future reference frame have a fixed size. This may significantly simplify storage management.

Once the video encoder 100 has entirely encoded the present frame 201, the reference frame memory 108 will comprise the encoded representation of the future reference frame. As mentioned hereinbefore, the video encoder 100 may use the encoded representation of the future reference frame that is stored in the reference frame memory 108 to encode a subsequent frame.

The present frame 201 is thus encoded on the basis of an encoded representation of the reference frame that has previously been generated by the reference frame compression module 104 in a manner as described hereinbefore. Consequently, the encoded representation of the reference frame, which is present in the reference frame memory 108, is in the form of respective encoded portions of the reference frame. In order to encode the present frame 201, the reference frame decompression module 105 successively retrieves certain encoded portions of the reference frame from the reference frame memory 108. The reference frame decompression module 105 then decodes these encoded portions, so as to obtain decoded versions of the encoded portions that have been retrieved from the reference frame memory 108. These decoded versions are transferred to the cache memory 107.

The reference frame decompression module 105 may manage this process of successive retrieval and decoding in order to ensure that an appropriate fraction of a representation of the reference frame is present in the cache memory 107. The appropriate fraction allows the motion estimation module 102 to identify, for the present portion of the present frame 201, the similar portion in the reference frame thereby generating the motion vector. This process is explained in greater in what follows.

FIG. 5 conceptually illustrates the fraction of the reference frame present in the cache memory 107 in relation to the present portion of the present frame 201. In this figure, reference numeral 500 designates the reference frame, reference numeral 501 designates the fraction of the reference frame present in the cache memory 107, and reference numeral 502 designates the present portion of the present frame. In this example, it is assumed that the respective encoded portions of the reference frame, when decoded, have a size equal to that of the respective portions of the present frame 201 to be encoded, such as, for example, 64×64 pixels. Further, the fraction 501 of the reference frame that is present the cache memory 107 comprises an array of 3×3 decoded versions of encoded respective portions of the reference frame. This array has a center portion that has a position within the reference frame corresponding with a position of the present portion in the present frame 201 to be encoded. In FIG. 5, the search window within which the motion estimation module 102 searches is also indicated and designated by reference numeral 503.

The cache memory management module 113 in the reference frame decompression module 105 has information about the position of the present portion 502 in the present frame 201 to be encoded. The cache memory management module 113 can obtain this information from the indicators in the data stream 206 illustrated in FIG. 2, which the video encoder 100 receives illustrated in FIG. 1 receives. The cache memory management module 113 can thus determine the encoded respective portions of the reference frame of which the decoded version should be present in the cache memory 107.

In the example presented hereinbefore, six (6) of these portions are generally already present in the cache memory 107. This because these portions formed part of a previous fraction of the representation of the reference frame that served as a basis for encoding a preceding portion of the present frame 201 to be encoded. Thus, in general, the reference frame decompression module 105 should access the reference frame memory 108 when a new portion of the present frame 201 is to be encoded. In the example introduced hereinbefore, this access is limited to retrieving and decoding three (3) respective encoded portions of the reference frame only. The access is somewhat more comprehensive when a new portion of the present frame 201 is positioned at a boundary of the reference frame.

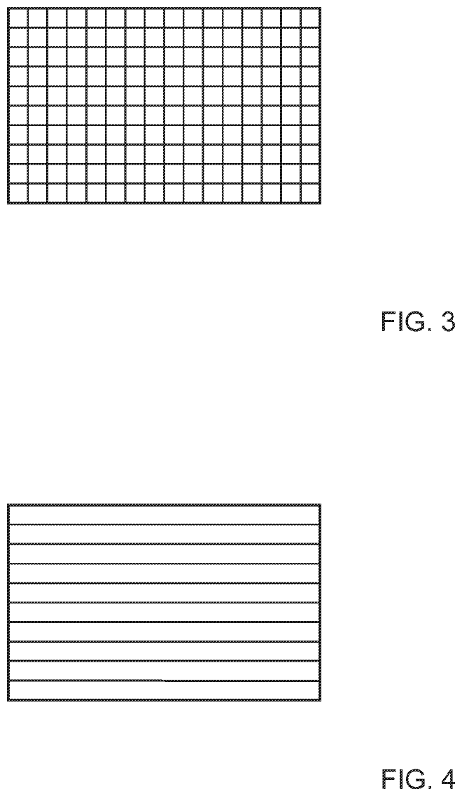

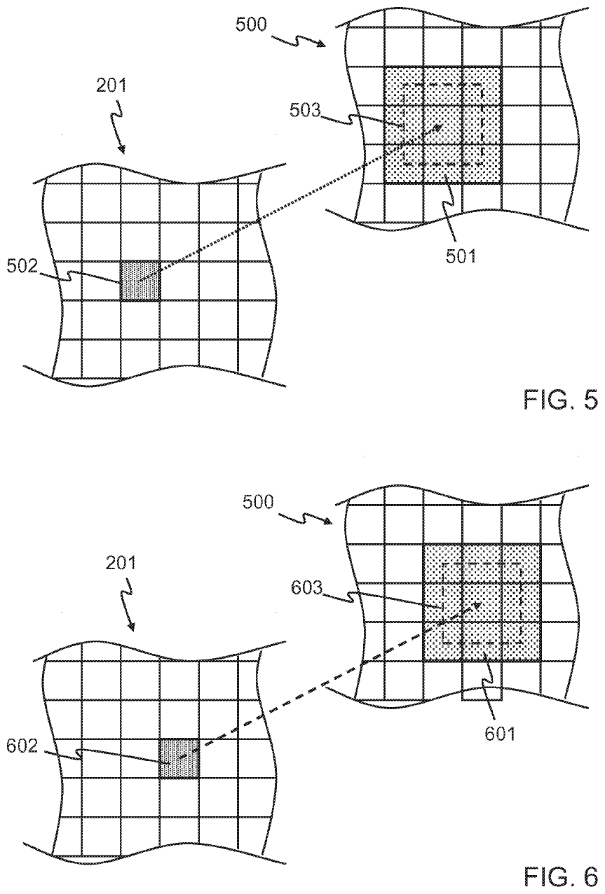

FIG. 6 conceptually illustrates another fraction of the reference frame that will be present in the cache memory 107 in relation to a subsequent portion of the present frame 201 to be encoded, which immediately follows the present portion. In this figure, reference numeral 601 designates the other fraction of the reference frame that will be present in the cache memory 107, and reference numeral 602 designates the subsequent portion of the present frame. In FIG. 6, a subsequent search window within which the motion estimation module 102 will then search is also indicated and designated by reference numeral 603. There is significant overlap between the search window 503 and the subsequent search window 603.

FIG. 6 further illustrates that in order for the other fraction 601 to be present in the cache memory 107, it is sufficient that the reference frame decompression module 105 retrieves and decodes only three (3) respective encoded portions of the reference frame. This in combination with the respective encoded portions being compressed makes that band width requirements for data transfer between the chip 109, which carries out encoding operations, and reference frame memory 108, are significantly relaxed. This allows low power consumption of the video encoder 100 illustrated in FIG. 1.

As mentioned hereinbefore, the video encoder 100 illustrated in FIG. 1 can provide image quality that is relatively close to what a conventional video encoder 100 can provide, which does not compress reference frames or slightly compresses reference frames in a lossless or quasi-lossless manner. Surprisingly, the lossy compression that is applied need not significantly reduce image quality. The same holds for restricting the search window in motion estimation to what can be stored in the cache memory 107. What is more, the following has surprisingly been found. When an encoded sequence of frames generated by the video encoder 100 illustrated in FIG. 1 is decoded by a decoder that operates without a reference frame buffer system similar to that of the encoder, a decoded sequence of frames is obtained that has a visual quality that is at least equivalent to that of a decoded sequence of frames obtained from a decoder with a reference frame buffer system similar to that of the encoder. That is, there is no need for symmetry between a decoder and the video encoder 100 illustrated in FIG. 1 in terms of reference frames. This particularly holds when the video encoder 100 illustrated in FIG. 1 encodes the sequence of frames with a compression ratio that is relatively high so that a relatively low rate data stream is generated. Further, in order to achieve a satisfactory image quality, the video encoder may encode the sequence of frames so that within a time interval of less than 30 seconds there are at least two frames that are encoded in the intra-frame manner. In certain cases, this time interval may be less than 10 seconds.

FIG. 7 illustrates a relationship between image quality and encoded video bit rate for various video encoding and decoding schemes, which are all HEVC-based. FIG. 7 provides a graph 700 having a horizontal axis that represents an encoded video bit rate expressed in kilobits per second and a vertical axis representing image quality expressed as peak-signal-to-noise ratio (PSNR) in units of decibel (dB). The relationship illustrated by the graph 700 is based in encoding a sequence of 500 frames captured by a camera at a rate of fifty (50) frames per second. These frames have a width of 1920 pixels and a height of 1080 pixels. A pixel is represented in a three (3) components space YCbCr with a 4:2:0 chroma sub-sampling and a precision of eight (8) bits per component. Therefore each pixel is represented by twelve (12) bits.

The graph 700 comprises five curves 701-705. A first curve 701 with dot-marked points shows the relationship between image quality and encoded video bit rate for an encoding and decoding scheme without any compression of reference frames. The first curve 701 may thus be regarded as a reference curve, which indicates a best performance in terms of image quality as a function of encoded video bit rate.

A second curve 702 with square-marked points and a third curve 703 with upward triangle-marked points show the relationship between image quality and encoded video bit rate for an encoding scheme wherein the video encoder illustrated in FIG. 1 compresses stripe-like portions of a reference frame, as illustrated in FIG. 4, by encoding these portions using JPEG XS. The stripe-like portions are encoded in accordance with a constant bit rate (CBR) scheme set to 3 bits per pixel (bpp). This corresponds to a reduction of 75 percent of the amount of data required to represent the reference frames in comparison to the case without compression of the reference frames. The second curve 702 with square-marked points applies when a decoding scheme is used wherein reference frames are compressed so that there is symmetry between the encoding scheme and the decoding scheme in terms of reference frames. The third curve 703 with upward triangle-marked points applies when a decoding scheme is used without compression of reference frames so that there is asymmetry between the encoding scheme and the decoding scheme in terms of reference frames.

The second curve 702 with square-marked points and the third curve 703 with upward triangle-marked points lie only slightly below the first curve 701 with dot-marked points. This illustrates that compressing stripe-like portions of a reference frame, as illustrated in FIG. 4, with a compression ratio of at least 2, entails a relatively small loss of image quality only, even when encoded video bit rates are relatively high. In case encoded video bit rates are relatively low, loss of image quality may even be negligible.

The third curve 703 with upward triangle-marked points, which applies when there is asymmetry between the encoding scheme and the decoding scheme in terms of reference frames, lies only slightly below the second curve 702 with square-marked points, which applies when there is symmetry in this respect. This illustrates that asymmetry entails a relatively small loss of image quality only in this case. Thus, there is no need for a decoder that applies a reference frame compression identical or similar to that applied in the video encoder. The decoder may have a standard architecture.

A fourth curve 704 with star-marked points and a fifth curve 705 with downward triangle-marked points show the relationship between image quality and encoded video bit rate for an encoding scheme wherein the video encoder illustrated in FIG. 1 compresses block-like portions of a reference frame, as illustrated in FIG. 3, by encoding these portions using JPEG XS. The block-like portions are encoded in accordance with a constant bit rate (CBR) scheme set to 4 bits per pixel (bpp). This corresponds to a reduction of 66.66 percent of the amount of data required to represent the reference frame in comparison to the case without compression of the reference frames. That is, the block-like portions are encoded with a compression ratio that is slightly lower than that for encoding the stripe-like portions. The fourth curve 704 with star-marked points applies when a decoding scheme is used wherein reference frames are compressed so that there is symmetry between the encoding scheme and the decoding scheme in terms of reference frames. The fifth curve 705 with downward triangle-marked points applies when a decoding scheme is used without compression of reference frames so that there is asymmetry between the encoding scheme and the decoding scheme in terms of reference frames.

The fourth curve 704 with star-marked points and the fifth curve 705 with downward triangle-marked points lie somewhat below the second curve 702 with square-marked points and the third curve 703 with upward triangle marked points. This illustrates that compressing block-like portions of a reference frame, as illustrated in FIG. 3, entails somewhat more loss of image quality than compressing stripe-like portions.

At relatively high encoded video bit rates, the fifth curve 705 with downward triangle-marked points, which applies when there is asymmetry between the encoding scheme and the decoding scheme in terms of reference frames, lies below the fourth curve 704 with star-marked points, which applies when there is symmetry in this respect. This illustrates that asymmetry entails a potentially noticeable loss of image quality at relatively high encoded video bit rates only.

However, surprisingly, at relatively low encoded video bit rates, the fifth curve 705 with downward triangle-marked points, which applies when there is asymmetry between the encoding scheme and the decoding scheme in terms of reference frames, lies somewhat above the fourth curve 704 with star-marked points, which applies when there is symmetry in this respect. This illustrates that, at relatively low encoded video bit rates, asymmetry may provide better image quality than symmetry. In this case, it may thus be preferable to use a decoder having a standard architecture rather than a decoder that applies a reference frame compression identical or similar to that applied in the video encoder.

In general, the graph 700 presented in FIG. 7 shows that the video encoder illustrated in FIG. 1, in which bandwidth requirements are relaxed allowing low power consumption, can provide satisfactory image quality. The video encoder illustrated in FIG. 1 is particularly suited in applications where encoded video data rates are relatively low. This is because, at low rates, a relatively coarse quantization is applied by the main encoding module 103 of the video encoder illustrated in FIG. 1 so that a relatively small portion of the encoded video represents residuals associated with motion compensation. Most of the information comprised in the encoded video concerns motion data and mode information.

There is no need for a decoder that applies a reference frame compression identical or similar to that applied in the video encoder illustrated in FIG. 1. The decoder may have a standard architecture, which is even preferable in case the case of compressing block-like portions of reference frames and relatively low encoded video bit rates.

Stated differently, a sequence of frames can be encoded in the following manner so as to obtain an encoded sequence of frames. An inter-frame prediction algorithm IPENC uses a Reference Frame Buffer System to store and retrieve reference frames used by IPENC, The Reference Frame Buffer System operates according to a set of parameters PRFBS={NB, RESB, BPPB, SE, RESL, SL, FBC, RESFBC, BPPFBC, DR}. The Reference Frame Buffer System stores and retrieves pixels of NB frames, of resolution RESB, whose pixels are coded on BPPB bits per pixel, The Reference Frame Buffer System includes:

an external memory ME of size SE to store the NB frames;

a frame buffer compression codec FBC to compress subframes of said frames, of resolution RESFBC, with BPPFBC bits per pixel:

an internal memory ML, of size SL, to store one frame or a part of frame of resolution RES: and

a data re-use algorithm DR, to prefetch a part of frame from the external memory ME to the internal memory ML.

Respective parameters in the set of parameter have respective values so that when the encoded sequence of frames is decoded by a decoder that operates without a frame buffer compression codec FBC, a decoded sequence of frames is obtained that has a visual quality that is at least equivalent to a visual quality of a decoded sequence of frames that a symmetrical decoder would provide, the symmetrical decoder comprising the same frame buffer compression codec FBC as the encoder.

The FBC codec may be based on JPEG XS. The encoding may be in conformity with the standard HEVC/ITU-T H.265. The data reuse algorithm DR may be either a Level-C scheme or a Level-D scheme.

### Notes

The embodiments described hereinbefore with reference to the drawings are presented by way of illustration. The invention may be implemented in numerous different ways. In order to illustrate this, some alternatives are briefly indicated.

The invention may be applied in numerous types of products or methods that involve encoding a sequence of frames. In the presented embodiments, it is mentioned that a video encoder in accordance with the invention may be of the HEVC type. In other embodiments, the video encore may apply a different standard, a different video encoding scheme.

There are numerous different ways of implementing a reference frame compression module in a video encoder in accordance with the invention. In the presented embodiments, it is mentioned that the reference frame compression module may apply a JPEG XS encoding scheme. In other embodiments, the reference frame compression module may apply a different encoding scheme.

The term “frame” should be understood in a broad sense. This term may embrace any entity that may represent an image, a picture.

In general, there are numerous different ways of implementing the invention, whereby different implementations may have different topologies. In any given topology, a single entity may carry out several functions, or several entities may jointly carry out a single function. In this respect, the drawings are very diagrammatic. There are numerous functions that may be implemented by means of hardware or software, or a combination of both. A description of a hardware-based implementation does not exclude a software-based implementation, and vice versa. Hybrid implementations, which comprise one or more dedicated circuits as well as one or more suitably programmed processors, are also possible. For example, various functions modules described hereinbefore with reference to the figures may be implemented by means of one or more suitably programmed processor, whereby a computer program may cause a processor to carry out one or more operations that have been described.

There are numerous ways of storing and distributing a set of instructions, that is, software, which allows a video encoder to operate in accordance with the invention. For example, software may be stored in a suitable device readable medium, such as, for example, a memory circuit, a magnetic disk, or an optical disk. A device readable medium in which software is stored may be supplied as an individual product or together with another product, which may execute the software. Such a medium may also be part of a product that enables software to be executed. Software may also be distributed via communication networks, which may be wired, wireless, or hybrid. For example, software may be distributed via the Internet. Software may be made available for download by means of a server. Downloading may be subject to a payment.

The remarks made hereinbefore demonstrate that the embodiments described with reference to the drawings illustrate the invention, rather than limit the invention. The invention can be implemented in numerous alternative ways that are within the scope of the appended claims. All changes that come within the meaning and range of equivalency of the claims are to be embraced within their scope. Any reference sign in a claim should not be construed as limiting the claim. The verb “comprise” in a claim does not exclude the presence of other elements or other steps than those listed in the claim. The same applies to similar verbs such as “include” and “contain”. The mention of an element in singular in a claim pertaining to a product, does not exclude that the product may comprise a plurality of such elements. Likewise, the mention of a step in singular in a claim pertaining to a method does not exclude that the method may comprise a plurality of such steps. The mere fact that respective dependent claims define respective additional features, does not exclude combinations of additional features other than those reflected in the claims.

1. An encoder (100) adapted to encode a sequence of frames (200) so as to obtain an encoded sequence of frames, the encoder comprising:
a motion estimation module (102) adapted to identify for a portion of a frame (201) to be encoded, a similar portion in a reference frame (500), the reference frame being a decoded version of an already encoded frame;
wherein the encoder comprises a reference frame buffer system including:
a reference frame compression module (104) adapted to independently encode respective portions of the reference frame so as to obtain respective encoded portions of the reference frame, whereby the respective portions of the reference frame that are independently encoded are at least as large as the portion of the frame to be encoded;
a reference frame memory (108) adapted to temporarily store the respective encoded portions of the reference frame as an encoded representation of the reference frame;
a reference frame decompression module (105) adapted to decode an encoded portion of the reference frame stored in the reference frame memory, so as to obtain a decoded version of the encoded portion of the reference frame; and
a cache memory (107) adapted to store a set of contiguous decoded versions of encoded portions of the reference frame,
whereby the motion estimation module is adapted to access the cache memory so as to identify the similar portion in the reference frame among the set of contiguous decoded versions of encoded portions of the reference frame.

2. An encoder according to claim 1, wherein the respective portions of the reference frame (500) that are independently encoded by the reference frame compression module (104) have a width of at least 64 pixels and a height of at least 32 pixels.

3. An encoder according to claim 2, wherein the respective portions of the reference frame (500) that are independently encoded by the reference frame compression module (104) have a size of at least 64 by 64 pixels.

4. An encoder according to claim 3, wherein the respective portions of the reference frame (500) that are independently encoded by the reference frame compression module (104) have a size of at least 64 pixels in height and a width corresponding to that of the frames in the sequence of frames (200).

5. An encoder according to any of claims 1 to 4, wherein the motion estimation module (102) is adapted to identify the similar portion of the reference frame (500) within a search window (503, 603) that has a fixed position with respect to the portion of the frame to be encoded.

6. An encoder according to any of claims 1 to 5, wherein the reference frame compression module (104) operates in accordance with a constant data rate encoding scheme,

7. An encoder according to any of claims 1 to 6, wherein the reference frame compression module (104) is adapted to systematically provide a compression ratio of at least 2.

8. An encoder according to claim 7, wherein the compression ratio depends on a size of the respective portions of the reference frame (500) that are independently encoded by the reference frame compression module (104).

9. An encoder according to any of claims 1 to 8, wherein the reference frame buffer system is adapted to store a boundary portion of the reference frame in the reference frame memory (108) in its original version, without being encoded, if the boundary portion of the reference frame is smaller than the respective portions of the reference frame that are encoded for storage in the reference frame memory.

10. An encoder according to any of claims 1 to 9, wherein the encoder is adapted to encode the sequence of frames (200) so that within a time interval of less than 30 seconds there are at least two frames that are encoded in an intra-frame manner.

11. An encoder according to any of claims 1 to 10, wherein the encoder is adapted to encode the sequence of frames (200) with a compression ratio that is high to the extent that when the encoded sequence of frames is decoded by a decoder that operates without a reference frame buffer system similar to that of the encoder, a decoded sequence of frames is obtained that has a visual quality that is at least equivalent to that of a decoded sequence of frames obtained from a decoder with a reference frame buffer system similar to that of the encoder.

12. An encoder according to any of claims 1 to 11, wherein the reference frame compression module (104) and the reference frame decompression module (105) are based on JPEG XS.

13. An encoder method according to any of claims 1 to 12, wherein the encoder is adapted to operate in conformity with the standard HEVC/ITU-T H.265.

14. A method of encoding a sequence of frames (200) so as to obtain an encoded sequence of frames, the method comprising:
a motion estimation step in which for a portion of a frame (201) to be encoded, a similar portion in a reference frame (500) is identified, the reference frame being a decoded version of an already encoded frame;
wherein the method further comprises:
a reference frame encoding step in which respective portions of the reference frame are independently encoded so as to obtain respective encoded portions of the reference frame, whereby the respective portions of the reference frame are at least as large as the portion of the frame to be encoded;
a reference frame storage step in which the respective encoded portions of the reference frame are temporarily stored in a frame buffer memory (108) as an encoded representation of the reference frame;
a reference frame decoding step in which an encoded portion of the reference frame is retrieved from the reference frame memory and decoded, so as to obtain a decoded version of the encoded portion of the reference frame; and
a cache memory storage step in which a set of contiguous decoded versions of encoded portions of the reference frame is stored in a cache memory (107),
whereby, in the motion estimation step, the cache memory is accessed so as to identify the similar portion in the reference frame among the set of contiguous decoded versions of encoded portion of the reference frame.

15. A computer program for an encoder, the computer program comprising a set of instructions that enables the encoder to carry out the method according to claim 14.
